(19) United States
(12) Patent Application Publication
(10) Pub. No.: US 2016/0094616 A1
(43) Pub. Date: Mar. 31, 2016

(54) USING AN EMBEDDED WEB SERVER TO ALLOW A STANDARD MULTI-TASKING OPERATING SYSTEM TO MANAGE, CONTROL AND DISPLAY LIVE OR RECORDED CONDITION MONITORING DATA FROM REAL TIME HARDWARE

(71) Applicants: Alexander PINKERTON, Aberdeen (GB); Johannes Izak BOERHOUT, San Diego, CA (US); Travis BOTTALICO, La Mesa, CA (US)

(72) Inventors: Alexander PINKERTON, Aberdeen (GB); Johannes Izak BOERHOUT, San Diego, CA (US); Travis BOTTALICO, La Mesa, CA (US)

(73) Assignee: AKTIEBOLAGET SKF, Goteborg (SE)

(21) Appl. No.: 14/816,238

(22) Filed: Aug. 3, 2015

Related U.S. Application Data
(60) Provisional application No. 62/057,598, filed on Sep. 30, 2014.

(51) Int. Cl. H04L 29/08

(52) U.S. Cl. CPC H04L 67/025

(57) ABSTRACT

A machine condition monitoring system comprising a machine condition monitoring analysis device operating on a combination of one of an Operating System (OS) or a Real Time Operating System (RTOS) and an embedded web based server. The analysis device includes a communication circuit for communicating with an independent web-enabled computing device having non-RTOS operating system. The independent computing device provides web requests to the analysis device. The analysis device interprets the web requests as instruction sets and processes the requests accordingly. The analysis device obtains machine condition data from one or more deployed sensors. The analysis device returns processed data in a form of one or more web pages. The communication network can integrate an intermediary communication device, wherein the intermediary communication device introduces a capability of translating Highway Addressable Remote Transducer (HART) transmissions into other communication protocols, such as Wi-Fi.

### CROSS-REFERENCE TO RELATED APPLICATIONS

This Utility application is a Non-Provisional Utility patent application claiming the benefit of U.S. Provisional Patent Application Ser. No. 62/057,598, filed on Sep. 30, 2014, which is included by reference in its entirety.

### BACKGROUND OF THE INVENTION

1. Field of the Invention

The present invention relates to a condition monitoring system. More specifically, the present invention relates to a condition monitoring system employing a web server enabling processing of HTTP requests to control condition monitoring hardware and present information in formatted web pages.

2. Discussion of the Related Art

Offline condition monitoring devices are built on a Real Time Operating System, (RTOS), such as Microsoft Windows CE RTOS. This operating system differs from normal multi-tasking operating systems, such as Windows, iOS, Android, Linux, and the like, in that the RTOS is intended to serve “real-time” application requests. This means that during critical system tasks, external events (such as screen updates, or mouse clicks etc.) can be “masked out” until that critical task is complete. If this was not the case, then real-time data would suffer “jitter” whenever external events (or interrupts) were received by the processor.

Although Real Time Operating Systems (RTOS's) are amazingly configurable, it is common practice to limit the default user interface of these operating systems to just a few basic controls, or worse, no user controls. This limitation imposes a requirement to the system builder (the firmware creator) to design and implement their own “custom user interface” to complement the RTOS firmware.

Much as this custom user interface philosophy will work with devices such medical equipment; vending machines; automotive dashboard controllers; point of sale and ticket dispensers; electronic test equipment, etc. the downside is that there is little to no commonality between devices at the user interface level. This, in turn, not only adds to the expense of developing the system, it also necessitates the need for additional user training once that system is ready and deployed for use.

What is desired is a “best of both worlds” solution wherein offline condition monitoring data can be collected using “off the shelf” tablet computers (which employ common and familiar operating systems), but which, at the same time, can communicate to hardware components using a Real Time Operating System (RTOS).

### SUMMARY OF THE INVENTION

The present invention is directed towards an adaptation enabling an interface between “off the shelf” tablet computers, portable computers, or other browser enabled computing devices and monitoring or operational controllers employing a Real Time Operating System (RTOS).

A first aspect of the present invention introduces a user interface and operating control system for a machine condition monitoring analysis device, the system comprising:

a machine condition monitoring analysis device including:
an analyzer printed circuit assembly (PCA) comprising a microprocessor and digital memory device assembled to a printed circuit board,
at least one analog channel adapted for communication with a condition monitoring sensor, the at least one analog channel being in signal communication with the microprocessor,
a communication circuit adapted for communication with a separate computing device comprising a compatible communication circuit,
a Operating System (OS) embedded within one of the microprocessor and digital memory device, wherein the RTOS is adapted to serve real time application requests, and
an embedded web based server, wherein the web based server is adapted to process externally provided Hypertext Transfer Protocol (HTTP) requests provided by the separate computing device and return information as formatted web pages

In a second aspect, the Operation System (OS) can be a Real Time Operating System (RTOS).

In another aspect of the present invention, the communication circuit operates in accordance with a wired communication protocol. The wired communication protocol can be Ethernet, Universal Serial Bus (USB), and the like.

In yet another aspect of the present invention, the communication circuit operates in accordance with a wireless communication protocol. The wireless communication protocol can be Wi-Fi, Bluetooth, Highway Addressable Remote Transducer (HART), and the like.

It is noted that the Wi-Fi Alliance defines Wi-Fi as any “wireless local area network (WLAN) products that are based on the Institute of Electrical and Electronics Engineers' (IEEE) 802.11 standards”.

It is noted that Bluetooth is a wireless technology standard for exchanging data over short distances (using short-wavelength UHF radio waves in the ISM band from 2.4 to 2.485 GHz) from fixed and mobile devices, and building personal area networks (PANs). Bluetooth was originally conceived as a wireless alternative to the wired RS-232 data communication protocol. Bluetooth is managed by the Bluetooth Special Interest Group (SIG), which has more than 20,000 member companies in the areas of telecommunication, computing, networking, and consumer electronics. Bluetooth was standardized under IEEE 802.15.1.

In yet another aspect of the present invention, the machine condition monitoring analysis device is configured with at least one of a media access control address (MAC address) and an Internet Protocol address (IP address).

It is noted: The media access control address (MAC address) is a unique identifier assigned to network interfaces for communications on the physical network segment. MAC addresses are used as a network address for most IEEE 802 network technologies, including Ethernet. Logically, MAC addresses are used in the media access control protocol sublayer of the OSI reference model.

It is also noted: The IP Address is a numerical label assigned to each device (e.g., computer, printer, tablet, scanner, and the like) participating in a computer network that uses the Internet Protocol for communication. An IP address serves two principal functions: host or network interface identification and location addressing. The role of the IP Address has been characterized as follows: “A name indicates what we seek. An address indicates where it is. A route indicates how to get there.”

In yet another aspect, the machine condition monitoring analysis device further comprises a portable power supply, wherein the portable power supply can be provided in a format of a battery, a super capacitor, and the like.

In yet another aspect of the present invention, the machine condition monitoring analysis device further comprises a recharging circuit for recharging the portable power supply. The recharging circuit can employ a wireless recharging circuit, a solar energy converter, a motion energy generator, and the like.

In yet another aspect, the machine condition monitoring analysis device is integrated into a wireless network.

In yet another aspect, the machine condition monitoring analysis device is arranged in direct wireless communication with a tablet or other portable computing device.

In yet another aspect, the machine condition monitoring analysis device is arranged in indirect wireless communication with a tablet or other portable computing device, wherein the communication is linked through a network bridge or a wireless gateway. The wireless gateway can be a dual band wireless gateway.

In yet another aspect, the machine condition monitoring analysis device is adapted for use as a network bridge.

In yet another aspect, the system can further comprise at least one wireless Highway Addressable Remote Transducer (HART) enabled device.

It is noted: HART (Highway Addressable Remote Transducer) Protocol is the global standard for sending and receiving digital information across analog wires between smart devices and control or monitoring system. More specifically, HART is a bi-directional communication protocol that provides data access between intelligent field instruments and host systems. A host can be any software application from technician's hand-held device or laptop to a plant's process control, asset management, safety or other system using any control platform.

In yet another aspect, the machine condition monitoring analysis device and the tablet can be integrated into a single assembly by a system cradle.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents a front, partially sectioned elevation view of an exemplary machine condition monitoring analysis device;

FIG. 2 presents a top view of the machine condition monitoring analysis device introduced in FIG. 1;

FIG. 3 presents a first side view of the machine condition monitoring analysis device introduced in FIG. 1, wherein the first side includes access to a reset actuator and wired communication ports;

FIG. 4 presents an isometric schematic view introducing communication paths between the machine condition monitoring analysis device and a tablet computing device;

FIG. 5 presents an isometric schematic view introducing a wireless communication link between the machine condition monitoring analysis device and the tablet computing device;

FIG. 6 presents an isometric schematic view introducing a wireless communication network between the machine condition monitoring analysis device, the tablet computing device, and a wireless Highway Addressable Remote Transducer (HART) enabled device, wherein the wireless communications are all routed through a network bridge or a wireless gateway;

FIG. 7 presents an isometric schematic view introducing a modified wireless communication network between the machine condition monitoring analysis device, the tablet computing device, the wireless Highway Addressable Remote Transducer (HART) enabled device, and the network bridge or a wireless gateway, wherein the machine condition monitoring analysis device is adapted for use as a network bridge; and

FIG. 8 presents a side elevation schematic view introducing a system cradle, wherein machine condition monitoring analysis device and the tablet computing device are assembled to and removably retained by the system cradle.

Like reference numerals refer to like parts throughout the several views of the drawings.

### DETAILED DESCRIPTION OF REPRESENTATIVE EMBODIMENTS

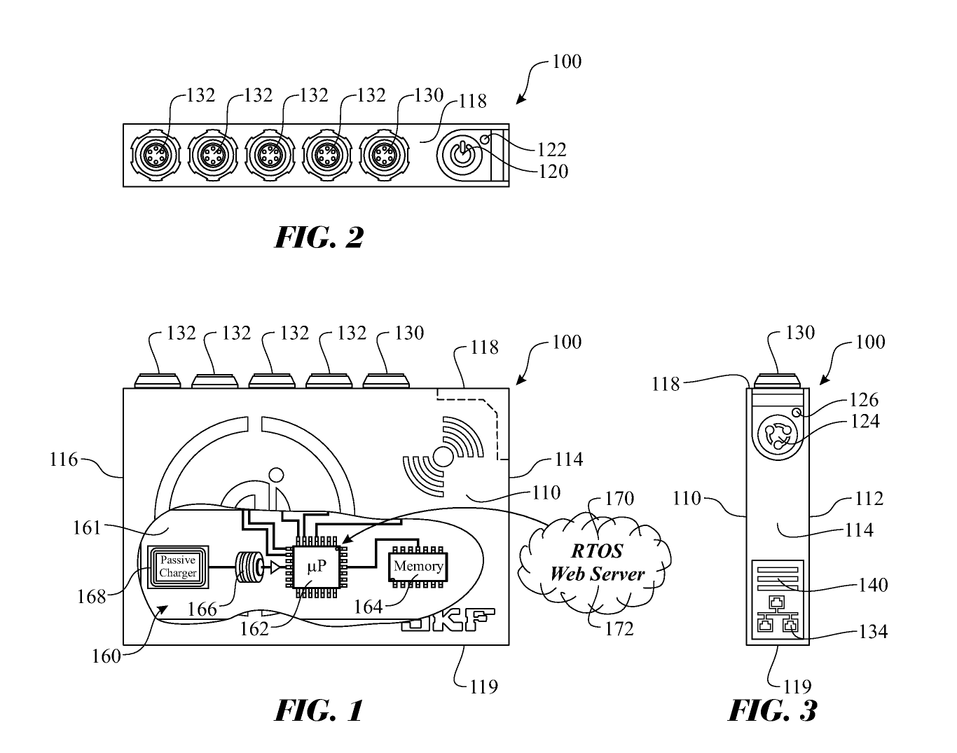

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A machine condition monitoring analysis device (microlog analyzer) 100, as introduced in FIGS. 1 through 3, is used to collect, analyze and present machine condition information. The exemplary machine condition monitoring analysis device (microlog analyzer) 100 is shown in three views, a front view illustrated in FIG. 1, a top view illustrated in FIG. 2, and a first side view illustrated in FIG. 3. Components of the machine condition monitoring analysis device (microlog analyzer) 100 are either contained within or assembled to a housing, wherein the housing includes an analyzer housing front panel 110, an analyzer housing rear panel 112, an analyzer housing first side panel 114, an analyzer housing second side panel 116, an analyzer housing top panel 118, and an analyzer housing bottom panel 119. The panels 110, 112, 114, 116, 118, 119 collectively form a rectangular shaped box defining a hollow interior. The housing can be designed to be rugged for commercial applications. The housing can additionally include features to become water resistant or even waterproof.

Operation of the machine condition monitoring analysis device (microlog analyzer) 100 is provided by an analyzer printed circuit assembly (PCA) 160 as visible through a cutaway section of an analyzer housing front panel 110 of the machine condition monitoring analysis device (microlog analyzer) 100. The analyzer printed circuit assembly (PCA) 160 includes a microprocessor 162 and a digital memory device 164 assembled in electro-mechanical communication with an analyzer printed circuit board (PCB) 161. Power can be provided to the analyzer printed circuit assembly (PCA) 160 by a portable power supply 166. The portable power supply 166 can be a battery, a plurality of batteries, a super capacitor and the like. The portable power supply 166 can be integrated onto the analyzer printed circuit board (PCB) 161 (as shown) or placed within the housing and connected to the analyzer printed circuit board (PCB) 161 by an electrically conductive element, such as wires, a flexible circuit, and the like. The portable power supply 166 is preferably rechargeable. Power for recharging can be provided using any suitable recharging power source and associated transfer mechanism, including a transformer providing power through a power plug, a transformer providing power through a passive charging circuit 168, a solar power converter, a motion actuated power generator, and the like.

It is understood that the digital memory device 164 can be integrated into the microprocessor 162. The machine condition monitoring analysis device (microlog analyzer) 100 can be activated and deactivated by an analyzer power switch 120. An analyzer power indicator 122 can be included to indicate when the machine condition monitoring analysis device (microlog analyzer) 100 is active. The analyzer power indicator 122 would be integrated into the machine condition monitoring analysis device (microlog analyzer) 100 at a location where the emitted light would be visible to the user. The analyzer power indicator 122 is preferably a green LED or other suitable illuminating indicator. A system reset button 124 enables the user to reset the machine condition monitoring analysis device (microlog analyzer) 100 for any reason. A system reset indicator 126 can be included to indicate when the machine condition monitoring analysis device (microlog analyzer) 100 is being reset. The system reset indicator 126 would be integrated into the machine condition monitoring analysis device (microlog analyzer) 100 at a location where the emitted light would be visible to the user, preferably adjacent to the system reset button 124. The system reset indicator 126 is preferably a red LED or other suitable illuminating indicator. Each of the analyzer power switch 120, the analyzer power indicator 122, the system reset button 124, and the system reset indicator 126 would be in electrical communication with the analyzer printed circuit assembly (PCA) 160 by wires, a wiring harness and respective connectors, a flexible circuit, and the like.

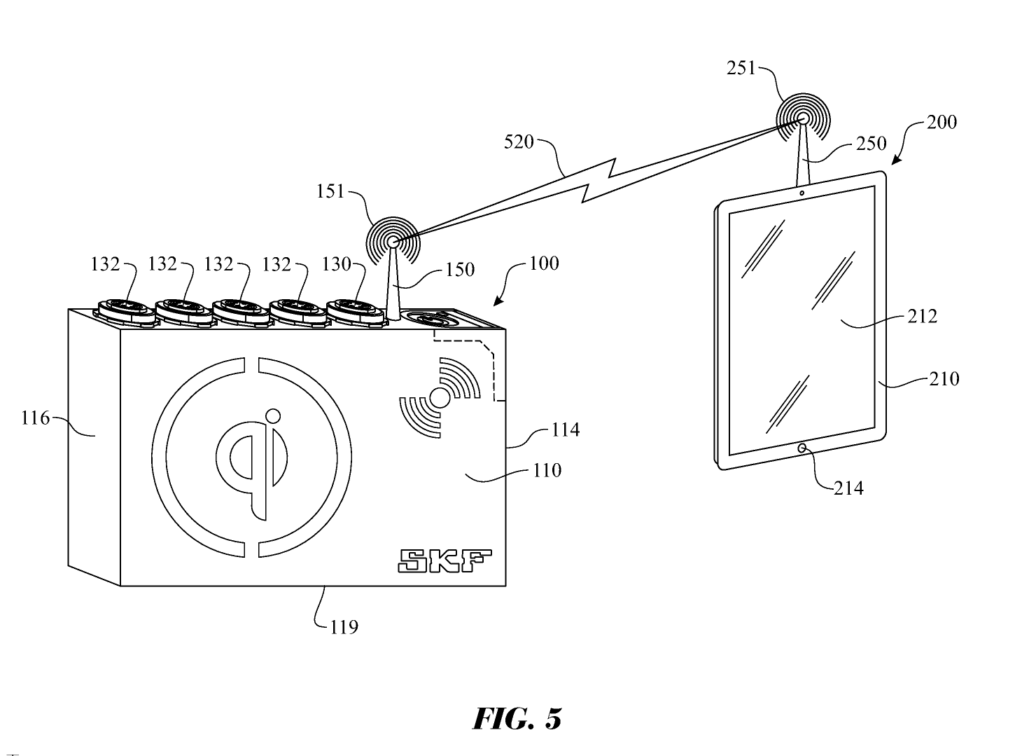

The machine condition monitoring analysis device (microlog analyzer) 100 includes one or more features enabling communication between the machine condition monitoring analysis device (microlog analyzer) 100 and an external computing device. A first exemplary communication feature is a concealed wired network communication port 134. The concealed wired network communication port 134 can be an Ethernet circuit, a Universal Serial Bus (USB) circuit, a Serial port, a Parallel port, and the like. A second communication feature is a wireless communication circuit, represented by a wireless communication system 150 (FIGS. 5, 6, 7). The wireless communication can employ any suitable wireless communication protocol, including Wi-Fi, Bluetooth, Zigbee, and the like. The wireless communication can be provided through one or more integrated circuits (not shown) that would be integrated into the analyzer printed circuit assembly (PCA) 160. Each of the communication interfaces 134, 150, would be in signal communication with the analyzer printed circuit assembly (PCA) 160 by integration with the analyzer printed circuit board (PCB) 161, wires, a wiring harness and respective connectors, a flexible circuit, and the like.

The machine condition monitoring analysis device (microlog analyzer) 100 additionally includes several elements for interfacing with condition monitoring sensors. A first element is a tachometer and external power 130. The tachometer and external power 130 can provide power to sensors and/or receiver power from an external source. The tachometer and external power 130 can additionally or alternatively acquire a rotational speed of a rotating element of a monitored machine. A second element is an analog input 132. The exemplary embodiment includes a number of analog inputs 132 to accommodate a sufficient number of sensors for monitoring a machine or other device. In the exemplary embodiment, each exemplary analog input 132 includes a pair of analog channels. Additionally, one or more wireless receivers or transceivers can be integrated into the machine condition monitoring analysis device (microlog analyzer) 100 for receiving data from wireless machine condition monitoring sensors. Each of the various elements for interfacing with condition monitoring sensors would be in signal communication with the microprocessor 162 of the analyzer printed circuit assembly (PCA) 160. Each of the tachometer and external power 130, the at least one analog input 132, the one or more wireless receivers or transceivers, and any other machine condition monitoring sensor interfaces would be in electrical communication with the analyzer printed circuit assembly (PCA) 160 by wires, a wiring harness and respective connectors, a flexible circuit, and the like. The microprocessor 162 would receive data provided by each of the various machine condition monitoring sensors, analyze the received data, and provide an output accordingly.

The machine condition monitoring analysis device (microlog analyzer) 100 can include a ventilation and/or cooling system 140. The ventilation and/or cooling system 140 can be provided in any suitable configuration, including vents formed through one or more of the panels, cooling fans located proximate heat generating elements, cooling fans located proximate vents through one of the panels, cooling fins in thermal communication with heat generating elements of the analyzer printed circuit assembly (PCA) 160, a liquid cooling system (although considerations for power consumption, etc. should be considered) and the like.

Functionality of the machine condition monitoring analysis device (microlog analyzer) 100 is provided by a set of digital instructions, often referred to as software, firmware, and the like. The digital instructions set is written to be run on a specific platform or operating system. The machine condition monitoring analysis device (microlog analyzer) 100 employs an Operating System (OS) 170. The OS 170 operates in conjunction with an embedded web server 172. In one implementation, the OS 170 can be a Real Time Operating System (RTOS).

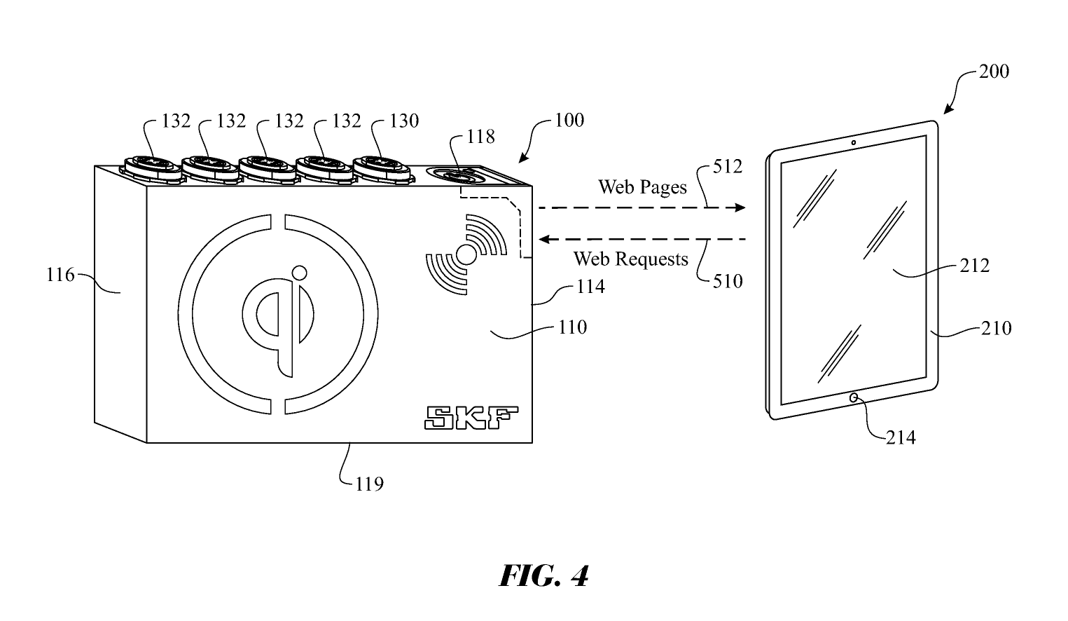

The user would provide requests through an external portable computing device (illustrated as an exemplary tablet/portable computing device 200), as illustrated in an exemplary block diagram shown in FIG. 4. It is noted that the tablet/portable computing device 200 would be a non RTOS operating device. The exemplary tablet/portable computing device 200 is illustrated in a form factor of a tablet. The tablet includes components commonly associated with a tablet/portable computing device 200 held within a portable computing device housing 210. The components include a computing mother board having a microprocessor, digital memory, one or more communication circuits, one or more connectors providing electro-mechanical connectivity to other devices, a power regulating circuit, and the like. The tablet/portable computing device 200 additionally includes a portable power supply integrated in electrical communication with the mother board, wherein the portable power supply can be a battery, a super capacitor, and the like. The motherboard, portable power supply, and other operation supporting components are integrated within a portable computing device housing 210 of the tablet/portable computing device 200.

The tablet/portable computing device 200 includes at least one user interface. The portable computing device touch display 212 provides both a machine output and a user input for communicating with the user. A portable computing device tactile user input 214 can be integrated into the tablet/portable computing device 200, wherein the portable computing device tactile user input 214 provides an additional user input capability. The portable computing device tactile user input 214 can be provided in any configuration, including a single tactile button; multiple tactile buttons in any format, such as a keyboard; a pointing device, such as a trackball, a track-pad, and the like; or any other suitable configuration. Although a tablet is illustrated in the various figures, it is understood that the tablet is representative of the tablet/portable computing device 200, wherein the tablet/portable computing device 200 can be any suitable portable computing device empowering an appropriate wireless communication protocol and web based software.

The machine condition monitoring analysis device (microlog analyzer) 100 and tablet/portable computing device 200 would preferably communicate with one another by way of an analyzer and portable computing device communication link 520, as illustrated in the exemplary schematic diagram presented in FIG. 5. The analyzer and portable computing device communication link 520 can be accomplished using any suitable wireless protocol, such as Wi-Fi, Bluetooth, Zigbee, and the like.

The web server 172 interacts with and processes externally provided HTTP web requests 510 provided by the tablet/portable computing device 200 and returns formatted web pages 512 to the request originator. The web requests 510 provided by the tablet/portable computing device 200 provides the required operating instruction set to the microprocessor 162 of the machine condition monitoring analysis device (microlog analyzer) 100. The microprocessor 162 recognizes, interprets, and processes the web requests 510 provided through the tablet/portable computing device 200. Configuration of the machine condition monitoring analysis device (microlog analyzer) 100 would be based upon the provided web requests 510. This provides several significant advantages over a currently provided firmware based solution. The web server based system introduces significant flexibility to the end user. The flexibility enables ease of adaptation of the machine condition monitoring analysis device (microlog analyzer) 100 for virtually any reasonable machine condition monitoring configuration; with an understanding of the limitations defined by the number of analog inputs 132 of the machine condition monitoring analysis device (microlog analyzer) 100, the types and locations of the machine condition monitoring sensors, and the like.

In operation: “Out of the Box” the machine condition monitoring analysis device (microlog analyzer) 100 will include a “default” configuration. The user would then access the concealed wired network communication port 134, and directly connect a computing device, such as a personal computer (PC), a laptop computer, or any other wired communication enabled computing device to the concealed wired network communication port 134. The user would then launch an Internet browser on the connected computing device, and enter either a default name or an Internet Protocol (IP) Address of the machine condition monitoring analysis device (microlog analyzer) 100. A configuration web page would then be generated by the machine condition monitoring analysis device (microlog analyzer) 100 and displayed within the Internet browser. From this configuration web page, the user could then assign a unique name to the device, as well as configure all aspects of its network settings (for example, setting security key or should the unit remember existing connections).

Assuming that this internal configuration data for the machine condition monitoring analysis device (microlog analyzer) 100 is lost, the user would then hold down the system reset button 124 for a predetermined period of time, such as five seconds. Holding down the system reset button 124 for a predetermined period of time will force the system reset indicator 126 to illuminate. It is preferred that the system reset indicator 126 would emit a red colored light, as this would be consistent with an expected result. Then, with the system reset button 124 still depressed, pressing the analyzer power switch 120, will power-cycle the machine condition monitoring analysis device (microlog analyzer) 100 and return the machine condition monitoring analysis device (microlog analyzer) 100 to the default factory state.

Once correctly configured, wirelessly connecting any tablet/portable computing device 200 to the machine condition monitoring analysis device (microlog analyzer) 100 would involve little more than identifying the given wireless access name of the machine condition monitoring analysis device (microlog analyzer) 100 and connecting to it. However, as this would limit the network functionality of the tablet/portable computing device 200, a second wireless network card within the machine condition monitoring analysis device (microlog analyzer) 100 would allow it to also wirelessly connect to any existing network infrastructure, thereby allowing access to whatever online resources (such as maintenance or historian data) is actually available.

Connectivity between the machine condition monitoring analysis device (microlog analyzer) 100 and the tablet/portable computing device 200 can be provided in a number of configurations. A first exemplary configuration was described above, wherein the machine condition monitoring analysis device (microlog analyzer) 100 and the tablet/portable computing device 200 are connected in a direct peer to peer configuration, as illustrated in FIG. 5.

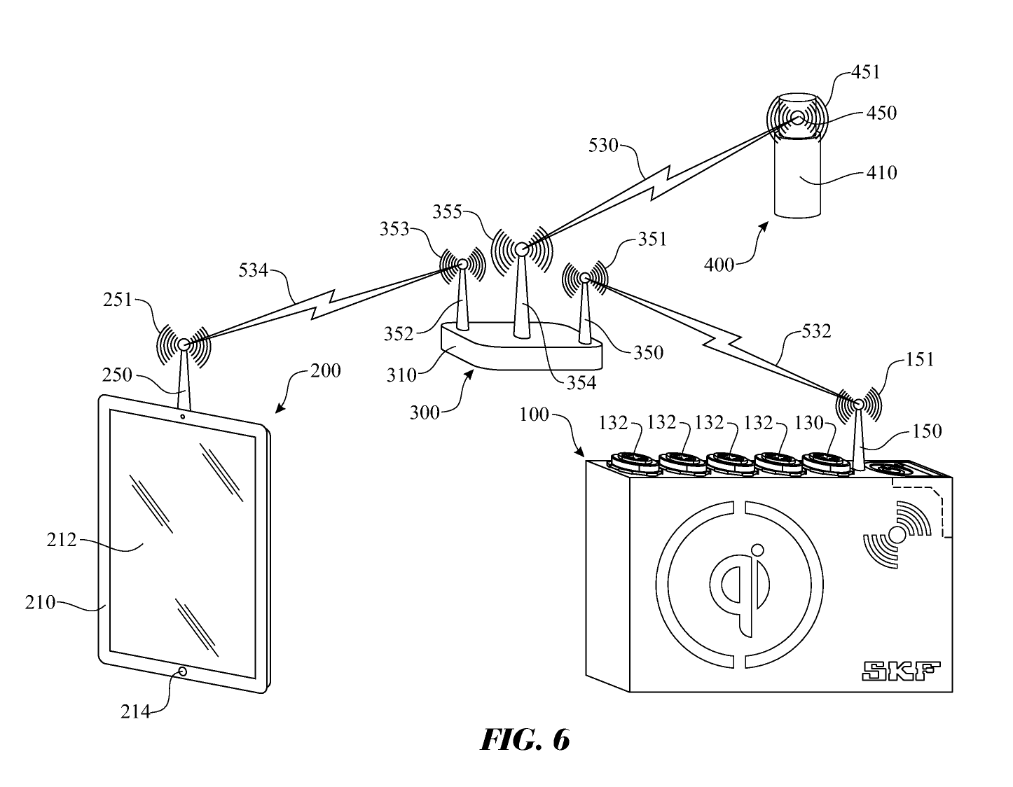

A second exemplary configuration is provided by an indirect connection, as illustrated in FIG. 6. The indirect connection employs an intermediary communication device 300 for connectivity between various wireless enabled elements. The intermediary communication device 300 includes a controller circuit and at least one communication circuit integrated within an intermediary communication device housing 310. In the exemplary embodiment, the at least one communication circuit includes a dual band wireless circuit, exemplified by a first band wireless communication system 350 and a second band wireless communication system 352. It is understood that the intermediary communication device 300 can utilize any wireless protocol, including Wi-Fi standards, such as 802.11a, 802.11b, 802.11g, 802.11n and the newer 802.11ac; Bluetooth, including long-range Bluetooth; Zigbee; and the like. Each of the first band wireless communication system 350 and second band wireless communication system 352 preferably operate in accordance with an IEEE 802.11n-2009 wireless networking standard or a newer IEEE 802.11ac. The intermediary communication device 300 can additionally incorporate a Highway Addressable Remote Transducer (HART) 354, wherein the Highway Addressable Remote Transducer (HART) 354 is adapted to communicate in accordance with a wireless Highway Addressable Remote Transducer (HART) protocol. HART (Highway Addressable Remote Transducer) Protocol is the global standard for sending and receiving digital information across analog wires between smart devices and control or monitoring system. More specifically, HART is a bi-directional communication protocol that provides data access between intelligent field instruments and host systems. A host can be any software application from technician's hand-held device or laptop to a plant's process control, asset management, safety or other system using any control platform. It is understood that the intermediary communication device 300 is representative of at least one of a network bridge, a wireless gateway, a dual band wireless gateway, a multi-band wireless gateway, and the like.

The system operates by providing web requests from the tablet/portable computing device 200 to the machine condition monitoring analysis device (microlog analyzer) 100. In the exemplary embodiment illustrated in FIG. 6, communication between the tablet/portable computing device 200 and the machine condition monitoring analysis device (microlog analyzer) 100 is provided through the intermediary communication device 300. The tablet/portable computing device 200 emits a wireless communication transmission 251 through a wireless communication system 250. The wireless communication transmission 251 is received by the second band wireless communication system 352 of the intermediary communication device 300. The intermediary communication device 300 in turn process the signal containing the web request and forwards the signal containing the web request to the predetermined destination; in this case the machine condition monitoring analysis device (microlog analyzer) 100. The intermediary communication device 300 emits a first band wireless communication transmission 351 through a first band wireless communication system 350. The first band wireless communication transmission 351 is received by the wireless communication system 150 of the machine condition monitoring analysis device (microlog analyzer) 100. The machine condition monitoring analysis device (microlog analyzer) 100 processes the received web requests and operates in accordance with the provided instructions. The requests would generally include directions associated with machine condition sensor data. The machine condition monitoring analysis device (microlog analyzer) 100 would obtain sensor data from an associated sensor, such as through the tachometer and external power 130, any of the analog inputs 132, a wireless Highway Addressable Remote Transducer (HART) enabled device 400 shown in the exemplary schematic illustrated in FIG. 6, or any other suitable machine condition sensing devices.

A configuration where machine condition sensors attached to each analog input 132 are known and represented by the analog input 132.

The system would preferably include a plurality of wireless Highway Addressable Remote Transducer (HART) enabled devices 400. Each wireless Highway Addressable Remote Transducer (HART) enabled device 400 includes a machine condition sensing system (not shown but understood by description) and a HART protocol transceiver 450 assembled within a HART enabled device housing 410. The HART protocol transceiver 450 is a transceiver operating in accordance with the HART protocol. The HART protocol transceiver 450 is capable of transmitting a HART communication transmission 451 and receiving an incoming signal from another device also operating in accordance with the HART protocol. The machine condition sensing system monitors the specific condition of the machine and returns the respective condition data to the intermediary communication device 300. The wireless Highway Addressable Remote Transducer (HART) enabled device 400 can continuously monitor the machine condition and transmit the associated machine condition data or monitor the machine condition upon request. The request would originate from the machine condition monitoring analysis device (microlog analyzer) 100. The machine condition monitoring analysis device (microlog analyzer) 100 would emit a wireless communication transmission 151, which is received by the first band wireless communication system 350. The intermediary communication device 300 would decode and interpret the signal received from the wireless communication system 150 and in turn transmit an appropriate HART communication transmission 355 from the Highway Addressable Remote Transducer (HART) 354, wherein the HART communication transmission 355 is directed towards a specific HART enabled device housing 410. The instruction set obtained from the wireless communication transmission 151 is translated from the inbound wireless communication protocol to an instruction set and embedded within a signal in accordance with the HART protocol. The instruction set is forwarded to the wireless Highway Addressable Remote Transducer (HART) enabled device 400 by way of the HART device and dual band wireless gateway communication link 530. The signal containing the embedded instruction set is transmitted as a HART communication transmission 355 from the Highway Addressable Remote Transducer (HART) 354. The emitted HART communication transmission 355 is received by the HART protocol transceiver 450 of the wireless Highway Addressable Remote Transducer (HART) enabled device 400. The wireless Highway Addressable Remote Transducer (HART) enabled device 400 decodes the HART communication transmission 355 and operates in accordance with the associated instruction set. Once the machine condition data is acquired, the wireless Highway Addressable Remote Transducer (HART) enabled device 400 forwards the information to the machine condition monitoring analysis device (microlog analyzer) 100 through the intermediary communication device 300.

In the exemplary embodiment, the wireless Highway Addressable Remote Transducer (HART) enabled device 400 would return the data to the intermediary communication device 300 by way of the HART device and dual band wireless gateway communication link 530. The HART device and dual band wireless gateway communication link 530 is established between the Highway Addressable Remote Transducer (HART) 354 of the intermediary communication device 300 and the HART protocol transceiver 450 of the wireless Highway Addressable Remote Transducer (HART) enabled device 400. The Highway Addressable Remote Transducer (HART) 354 emits a HART communication transmission 355, which is received by the HART protocol transceiver 450 and the HART protocol transceiver 450 emits a HART communication transmission 451, which is received by the Highway Addressable Remote Transducer (HART) 354. The intermediary communication device 300 translates the received signal from the HART protocol to the associated gateway protocol and forwards the machine condition data to the machine condition monitoring analysis device (microlog analyzer) 100 for analysis.

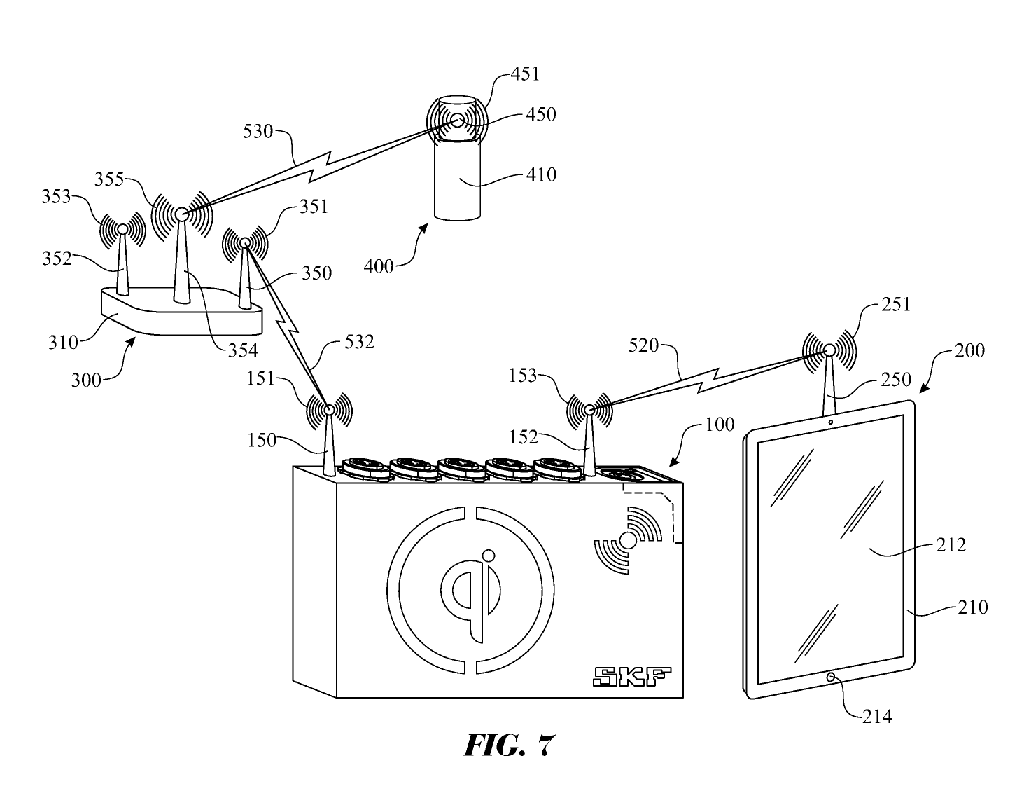

The data received from the wireless Highway Addressable Remote Transducer (HART) enabled device 400 is transferred to the machine condition monitoring analysis device (microlog analyzer) 100 for analysis by way the analyzer and dual band wireless gateway communication link 532. In the exemplary embodiment, the machine condition data is transferred from the intermediary communication device 300 to the machine condition monitoring analysis device (microlog analyzer) 100 by way of the analyzer and dual band wireless gateway communication link 532. The analyzer and dual band wireless gateway communication link 532 is established between the first band wireless communication system 350 of the intermediary communication device 300 and the wireless communication system 150 of the machine condition monitoring analysis device (microlog analyzer) 100. The first band wireless communication system 350 emits a first band wireless communication transmission 351, which is received by the wireless communication system 150. The machine condition monitoring analysis device (microlog analyzer) 100 decodes the machine data embedded within the first band wireless communication transmission 351. The machine condition monitoring analysis device (microlog analyzer) 100 would analyze the machine condition data and generate one or more web pages 512. The generated one or more web pages 512 are conveyed to the tablet/portable computing device 200 either through the intermediary communication device 300, as illustrated in FIG. 6 or directly, as illustrated in FIG. 7.

In the first exemplary configuration (FIG. 6), the machine condition monitoring analysis device (microlog analyzer) 100 communicates indirectly with the tablet/portable computing device 200 by way of the intermediary communication device 300. In this configuration, the machine condition monitoring analysis device (microlog analyzer) 100 connects to an available network as a “client” and is assigned an IP address by the network DNS Server. The tablet/portable computing device 200 then queries the machine condition monitoring analysis device (microlog analyzer) 100 as it would any other device. This would ideally be suited to situations where long term monitoring was required and the machine condition monitoring analysis device (microlog analyzer) 100 could be left in-situ and externally powered from a DC supply, wherein power would be received through the tachometer and external power 130. In accordance with the first exemplary configuration, the generated web pages 512 are transmitted using the wireless communication transmission 151, which is received by the first band wireless communication system 350 of the intermediary communication device 300. The intermediary communication device 300 in turn processes the signal containing the web page and forwards the signal containing the web page to the predetermined destination; in this case the tablet/portable computing device 200. In the exemplary schematic, the intermediary communication device 300 and the tablet/portable computing device 200 communicate by way of a portable computing device and dual band wireless gateway communication link 534. The web pages 512 are embedded within a second band wireless communication transmission 353 emitted by a second band wireless communication system 352. The second band wireless communication transmission 353 is received by the wireless communication system 250 of the tablet/portable computing device 200. The tablet/portable computing device 200 decodes the received signal and displays the web pages 512 upon the portable computing device touch display 212.

In the second exemplary configuration (FIG. 7), the machine condition monitoring analysis device (microlog analyzer) 100 communicates directly with the tablet/portable computing device 200. Here the machine condition monitoring analysis device (microlog analyzer) 100 uses two wireless cards to form a “network bridge”. This network bridge will allow the tablet/portable computing device 200 to access available network resources, while connecting to the machine condition monitoring analysis device (microlog analyzer) 100 in a direct “peer to peer” manner. This will allow the tablet/portable computing device 200 to not only query the machine condition monitoring analysis device (microlog analyzer) 100, but also reference other online resources—such as values output by the wireless Highway Addressable Remote Transducer (HART) enabled device 400. As shown in FIG. 5, the machine condition monitoring analysis device (microlog analyzer) 100 and the tablet/portable computing device 200 communicate with one another by way of an analyzer and portable computing device communication link 520. The generated web pages 512 are embedded within a second wireless communication transmission 153, which is emitted by a second wireless communication system 152. The second wireless communication transmission 153 is received by the wireless communication system 250 of the tablet/portable computing device 200. The tablet/portable computing device 200 decodes the received signal and displays the web pages 512 upon the portable computing device touch display 212.

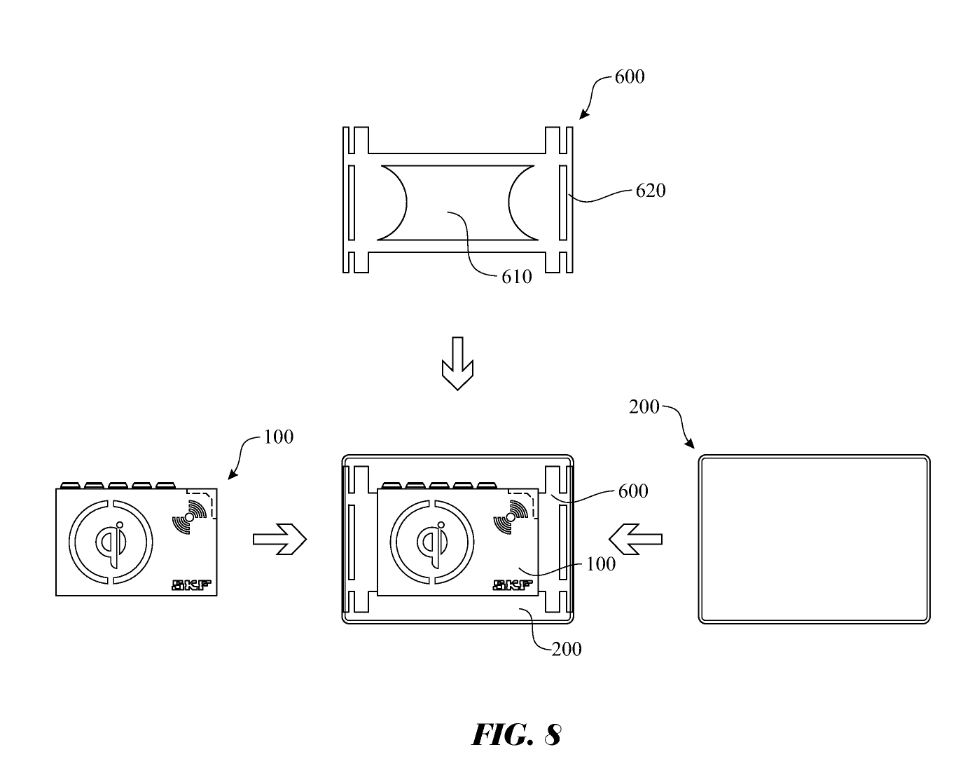

The machine condition monitoring analysis device (microlog analyzer) 100 and tablet/portable computing device 200 are integrated into a single solution for monitoring, obtaining, and analyzing machine conditions. It is understood that it would be advantageous to provide a device to combined both the machine condition monitoring analysis device (microlog analyzer) 100 and tablet/portable computing device 200 into a single assembly for ease of use, transport, and portability, as introduced in the illustration presented in FIG. 8. A system cradle 600 can include an analyzer carrying feature 610 and a tablet carrying feature 620. The machine condition monitoring analysis device (microlog analyzer) 100 is inserted into and carried by the analyzer carrying feature 610. The tablet/portable computing device 200 is inserted into and carried by the tablet carrying feature 620. The system cradle 600 would be preferably manufactured of a pliant material, such as rubber, silicone, and the like, wherein the pliant material would absorb impacts, protecting the equipment. It is understood that the system cradle 600 can be provided in a variety of sizes and shapes, wherein each system cradle 600 is adapted for a specific tablet/portable computing device 200, including tablets, portable computers, smart phones, and the like.

The disclosed system provides several advantages over the currently available machine condition monitoring solutions. Initially, the disclosed system allows any portable computing device, including a laptop, a tablet computer, a smart phone, and the like to display live condition monitoring data as web data returned from a “real time” (RTOS) data collection system acting as a web server. Additionally, the disclosed system allows “real time” condition monitoring applications to be constructed on common operating systems devices such as “off the shelf” laptop or tablet computers, thereby reducing UI complexity and user training requirements. This increases time to market, reduces development costs, improves user operation, among other advantages.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### LISTING OF REFERENCE NUMBERS

Ref. No. Description
100 machine condition monitoring analysis device (microlog analyzer)
110 analyzer housing front panel
112 analyzer housing rear panel
114 analyzer housing first side panel
116 analyzer housing second side panel
118 analyzer housing top panel
119 analyzer housing bottom panel
120 analyzer power switch
122 analyzer power indicator
124 system reset button
126 system reset indicator
130 tachometer and external power
132 analog input
134 concealed wired network communication port
140 ventillation and/or cooling system
150 wireless communication system
151 wireless communication transmission
152 second wireless communication system
153 second wireless communication transmission
160 analyzer printed circuit assembly (PCA)
161 analyzer printed circuit board (PCB)
162 microprocessor
164 digital memory device
166 portable power supply
168 passive charging circuit
170 Operating System (OS)
172 web server
200 tablet/portable computing device
210 portable computing device housing
212 portable computing device touch display
214 portable computing device tactile user input
250 wireless communication system
251 wireless communication transmission
300 intermediary communication device
310 intermediary communication device housing
350 first band wireless communication system
351 first band wireless communication transmission
352 second band wireless communication system
353 second band wireless communication transmission
354 Highway Addressable Remote Transducer (HART)
355 HART communication transmission
400 wireless Highway Addressable Remote Transducer (HART) enabled device
410 HART enabled device housing
450 HART protocol transceiver
451 HART communication transmission
510 web request
512 web page response
520 analyzer and portable computing device communication link
530 HART device and dual band wireless gateway communication link
532 analyzer and dual band wireless gateway communication link
534 portable computing device and dual band wireless gateway communication link
600 system cradle
610 analyzer carrying feature
620 tablet carrying feature

What is claimed is:

1. A machine condition monitoring analysis device comprising:
a machine condition monitoring analysis device housing;
an analyzer printed circuit assembly (PCA) comprising a microprocessor and digital memory device assembled to a printed circuit board, the analyzer printed circuit assembly (PCA) being carried within the machine condition monitoring analysis device housing;
at least one analog channel adapted for communication with a condition monitoring sensor, the at least one analog channel being in signal communication with the microprocessor;
a communication circuit adapted for communication with a separate computing device comprising a compatible communication circuit;
an Operating System (OS) embedded within one of the microprocessor and digital memory device, wherein the OS is adapted to serve real time application requests; and
an embedded web based server, wherein the web based server is adapted to process externally provided Hypertext Transfer Protocol (HTTP) requests provided by the separate computing device and return information as formatted web pages.

2. The machine condition monitoring analysis device as recited in claim 1, wherein the Operating System is a Real Time Operating System (RTOS).

3. The machine condition monitoring analysis device as recited in claim 1, further comprising a tachometer.

4. The machine condition monitoring analysis device as recited in claim 1, further comprising a portable power supply.

5. The machine condition monitoring analysis device as recited in claim 1, further comprising a portable power supply and a recharging circuit, wherein the recharging circuit includes a wireless charging feature.

6. The machine condition monitoring analysis device as recited in claim 1, wherein the housing is a rugged housing.

7. The machine condition monitoring analysis device as recited in claim 1, wherein the housing is a waterproof housing.

8. The machine condition monitoring analysis system as recited in claim 1, wherein the communication circuit includes at least one wired communication circuit and at least one wireless communication circuit.

9. A machine condition monitoring analysis system comprising:
a machine condition monitoring analysis device comprising:
a machine condition monitoring analysis device housing;
an analyzer printed circuit assembly (PCA) comprising a microprocessor and digital memory device assembled to a printed circuit board, the analyzer printed circuit assembly (PCA) being carried within the machine condition monitoring analysis device housing;
at least one analog channel adapted for communication with a condition monitoring sensor, the at least one analog channel being in signal communication with the microprocessor,
a machine condition monitoring analysis device communication circuit,
an Operating System (OS) embedded within one of the microprocessor and digital memory device, wherein the OS is adapted to serve real time application requests, and
an embedded web based server, wherein the web based server is adapted to process externally provided Hypertext Transfer Protocol (HTTP) requests provided by the separate computing device and return information as formatted web pages;
a machine condition sensor in communication with the machine condition monitoring analysis device; and
an independent portable computing device operating on a non RTOS operating system, the independent portable computing device comprising:
a computing mother board comprising a microprocessor and digital memory device assembled to a printed circuit board,
an independent portable computing device housing,
a portable computing device communication circuit assembled within the independent portable computing device housing,
a independent portable computing device display carried by the independent portable computing device housing, and
a web browser, wherein the microprocessor operates in accordance with the web browser, wherein the web browser generates web requests based upon user input and displays web pages based upon information provided;
wherein, the independent portable computing device generates web requests,
the web requests are transmitted from the independent portable computing device to the machine condition monitoring analysis device by a communication link provided between the machine condition monitoring analysis device communication circuit and the portable computing device communication circuit,
the web requests are interpreted as an instruction set by the one of the OS or the RTOS of the machine condition monitoring analysis device,
the machine condition monitoring analysis device accomplishes the instruction set and generates at least one we page,
the at least one web page is transmitted from the machine condition monitoring analysis device to the independent portable computing device by the communication link provided between the machine condition monitoring analysis device communication circuit and the portable computing device communication circuit, and
the at least one web page is presented upon the independent portable computing device display.

10. The machine condition monitoring analysis device as recited in claim 9, wherein the Operating System is a Real Time Operating System (RTOS).

11. The machine condition monitoring analysis system as recited in claim 9, further comprising an intermediary communication device, wherein the intermediary communication device is at least one of a network bridge, a wireless gateway, a dual band wireless gateway, and a multi-band wireless gateway.

12. The machine condition monitoring analysis system as recited in claim 11, wherein the system is configured having the machine condition monitoring analysis device and the independent portable computing device communicate indirectly with one another through the intermediary communication device.

13. The machine condition monitoring analysis system as recited in claim 11, wherein the intermediary communication device further comprises a communication system operating in accordance with a Highway Addressable Remote Transducer (HART) protocol.

14. The machine condition monitoring analysis system as recited in claim 13, wherein the machine condition sensor is a wireless Highway Addressable Remote Transducer (HART) enabled device.

15. The machine condition monitoring analysis system as recited in claim 13, wherein the system is configured having the machine condition monitoring analysis device and the independent portable computing device communicate indirectly with one another through the intermediary communication device.

16. The machine condition monitoring analysis system as recited in claim 13, wherein the system is configured having:
the machine condition monitoring analysis device communicate with the wireless Highway Addressable Remote Transducer (HART) enabled device indirectly with one another through the intermediary communication device; and
the machine condition monitoring analysis device and the independent portable computing device communicate directly with one another through the intermediary communication device.

17. The machine condition monitoring analysis system as recited in claim 9, further comprising a system cradle, wherein the machine condition monitoring analysis device and the independent portable computing device are each carried by the system cradle.

18. The machine condition monitoring analysis system as recited in claim 9, wherein the housing is a rugged housing.

19. The machine condition monitoring analysis system as recited in claim 9, wherein the housing is a waterproof housing.

20. The machine condition monitoring analysis system as recited in claim 9, wherein the machine condition monitoring analysis device communication circuit includes at least one wired communication circuit and at least one wireless communication circuit.
